(19) United States
(12) Patent Application Publication
(10) Pub. No.: US 2016/0066595 A1
(43) Pub. Date: Mar. 10, 2016

(54) MOLDED FOOD PRODUCT

(71) Applicant: NESTEC S.A., Vevey (CH)

(72) Inventors: Daniel Grolimund, Bolligen (CH); Markus Koch, Puidoux (CH)

(73) Assignee: NESTEC S.A., Vevey (CH)

(21) Appl. No.: 14/780,339

(22) PCT Filed: Apr. 17, 2014
(86) PCT No.: PCT/EP14/57853

§ 371 Date: Sep. 25, 2015

(30) Foreign Application Priority Data
Apr. 19, 2013 (EP) 13164428.8

(51) Int. Cl. A23G 1/30; A23G 3/50; A23G 3/34; A23G 1/00; A23G 1/54

(52) U.S. Cl. CPC A23G 1/305; A23G 1/0079; A23G 1/54; A23G 3/0097; A23G 3/50; A23V 2002/00

(57) ABSTRACT

This invention relates to a molded food product, preferably a confectionery product such as a chocolate product, having on its surface at least two relief fields that provide an edible optical element, and to a process for preparing such a molded food product.

### FIELD OF THE INVENTION

This invention relates to a molded food product, in particular a fat-based confectionery product such as a chocolate product, having on its surface at least two or three non-overlapping relief fields that provide an edible optical element. The invention also relates to a process and a mold for manufacturing such a molded food product.

### BACKGROUND OF THE INVENTION

It is generally known in the art that consumer appeal is influenced not only by texture and taste of a food product, but also, if not even primarily, by the visual aesthetics of the product. Therefore, the outer appearance and decoration of confections and other food stuffs has been a long standing concern of the food industry, and in particular to producers of confections, chocolates, candies and the like.

One way to enhance this outer appearance is a new trend named “edible holography”, where light effects are created on the food surface, producing images including rainbow-like color patterns, pictures, and changes in color or location of pictures or parts of pictures in dependency of the viewing angle.

The most common way to create light effects on the surfaces of chocolate is to add some material other than chocolate to the ingredients list. Most of the known processes require adding various additive materials to the ingredient list, and/or require subjecting the chocolate to very specific methods in order to obtain and preserve the desired effects.

For example, JP 2005253340 discloses a confectionery product having a corrugated pattern directly on its surface, which is supposed to provide a holographic effect. This pattern is composed of two different types of corrugation fields having identical shape and size, wherein the two different types of corrugation fields differ by the orientation of their corrugations, which is 90°.

WO 01/10464 relates to edible holographic products comprising a core and an outer layer of thermoformable material bearing a microrelief that conveys a holographic image or effect. This extra layer is to be formed from an aqueous solution of a thermoformable food grade material such as modified cellulose, modified food starch, gelatin, waxes or vegetable gums. Additives such as hygroscopic sugar, plasticizers and colorants are added to stabilize the relief, which may negatively affect the texture and taste of the product. Moreover, the layer of material that retains the microrelief is applied onto the core by printing or laminating, thus limiting the number of techniques for producing such holographic elements.

U.S. Patent Application No. 2004/0170725 relates to edible articles that incorporate optical elements such as holographic patterns, and various methods for producing such articles. These methods comprise molding of film forming materials such as cellulose polymers, complex starches and gels for building a substrate, and sealing together a plurality of substrates, each of which has emerged from a relief mold such that their sides on which relief gratings are defined are facing each other to form an optical gap between the optical elements.

U.S. Pat. No. 4,668,523 discloses a system for applying high resolution diffraction gratings to confections and other food products to produce edible holograms. The edible holographic element of this patent comprises an organic polymer selected from amino acid polymers and carbohydrates such as cellulose extracts and simple polysaccharides, i.e. sugars. Further ingredients such as plasticizers, softening agents, artificial sweeteners, food colorings and the like are added to the organic polymer for protection of the image and/or to change the flavor and texture of the holographic element.

It should be kept in mind that adding some material other than chocolate to the ingredient list may not only have a potentially detrimental effect of on texture and taste of the product, but that the incorporation of various additives also bares the risk of increasing the allergenic potential of the foodstuff. Moreover, most of the known methods require formation of different substrates, thus making additional sealing steps necessary to build a composite product.

In sum, there still exists a need for food products having improved optical elements such as holographic gratings and patterns that are able to produce visually interesting optical images and effects, wherein such optical elements do not impair the texture, taste and safety of the edible product. Moreover, there is still a need for an easy to perform, time- and cost-saving one-pot process for preparing such food products, which avoids the manufacturing of several separate product layers.

### SUMMARY OF THE INVENTION

These needs are met by the novel and easy to implement technology of the present invention, which provides molded food products, such as confectionery products, e.g. chocolates, that include light refracting effects such as printed patterns, logos and holographic elements on their surface, as well as a mold and a process for manufacturing such products without adding any additive and/or film-forming material to the confectionery mass.

Accordingly, in a first aspect, the present invention relates to a molded food product, preferably a confectionery product such as e.g. a chocolate product, presenting on its surface (1a) an optical element (2a) comprising at least three non-overlapping relief fields (3a), each relief field (3a) having at least two parallel straight indentation lines (4) providing an orientation of the relief field (3a), wherein the respective different relief fields (3a) are not in parallel orientation to each other.

A preferred embodiment of the present invention relates to the molded food product according to the first aspect, wherein (i) the depth (5) of the indentation lines (4) is from 0.03 mm to 1 mm; and/or the width (6) of the indentation lines (4) is from 0.1 mm to 2.0 mm.

Another preferred embodiment of the present invention relates to the molded food product according to the first aspect, wherein (i) the depth (5) of the indentation lines (4) is from 0.03 mm to 1 mm; and/or the width (6) of the indentation lines (4) is from 0.1 mm to 2.0 mm; and/or (ii) the cross-sectional profile of the indentation lines (4) is a concave (4a) or convex curve (4b); and/or (iii) the concave (4a) or convex curve (4b) of the indentation lines (4) is characterized by a tangential angle (10) of from 40° to 120°.

In a further preferred embodiment of the first aspect of the invention, the at least two parallel straight indentation lines (4) of the at least two non-overlapping relief fields (3a) are oriented at an angle of at least 10° to each other.

In a second aspect, the present invention relates to a molded food product, preferably a confectionery product such as e.g. a chocolate product, presenting on its surface (1a) an optical element (2a) comprising at least two non-overlapping relief fields (3a), each relief field (3a) having at least two parallel straight indentation lines (4) providing an orientation of the relief field (3a), wherein the at least two non-overlapping relief fields (3a) are oriented at an angle of at least 10° to each other, and wherein (i)the depth (5) of the indentation lines (4) is from 0.03 mm to 1 mm; and/or the width (6) of the indentation lines (4) is from 0.1 mm to 2.0 mm; (ii) the cross-sectional profile of the indentation lines (4) is a concave (4a) or convex curve (4b); and (iii) the concave (4a) or convex curve (4b) of the indentation lines (4) is characterized by a tangential angle (10) of from 40° to 120°.

In a preferred embodiment of the second aspect of the invention, the present invention relates to a molded food product, preferably a confectionery product such as e.g. a chocolate product, presenting on its surface (1a) an optical element (2a) comprising at least two non-overlapping relief fields (3a), each relief field (3a) having at least two parallel straight indentation lines (4) providing an orientation of the relief field (3a), wherein the at least two non-overlapping relief fields (3a) are oriented at an angle of at least 10° to each other, and wherein (i)the depth (5) of the indentation lines (4) is from 0.03 mm to 1 mm and the width (6) of the indentation lines (4) is from 0.1 mm to 2.0 mm; (ii) the cross-sectional profile of the indentation lines (4) is a concave (4a) or convex curve (4b); and (iii) the concave (4a) or convex curve (4b) of the indentation lines (4) is characterized by a tangential angle (10) of from 40° to 120°.

In a preferred embodiment of the first or second aspect of the invention, the optical element (2a) comprises from 4 to 200, from 10 to 150, from 20 to 100, or from 30 to 50 relief fields and wherein, preferably, these different relief fields are oriented in at least 5, 6, 7, 8, 9, 10, 15, 20, or 50 different directions.

In another preferred embodiment of the first or second aspect of the invention, the at least two non-overlapping relief fields (3a) are oriented at an angle of from 15° to 350°, from 20° to 300°, from 30° to 135°, from 45° to 90°, from 50° to 80°, or from 50° to 60°to each other.

In a further preferred embodiment of the first or second aspect of the invention the depth (5) of the indentation lines (4) is from 0.04 mm to 0.5 mm, more preferably from 0.04 to 0.1 mm, even more preferably from 0.05 to 0.1 mm, most preferably from 0.06 mm to 0.08 mm or from 0.06 to 0.09 mm. In a preferred embodiment the depth of the indentation lines is around 0.07 mm.

In another preferred embodiment of the first or second aspect of the invention, the width (6) of the indentation lines (4) is from 0.1 mm to 1.0 mm, preferably from 0.15 mm to 0.50 mm, more preferably from 0.20 mm to 0.40 mm. In some embodiments the width of the indentation lines is from about 0.20 mm to 0.30 mm.

In yet another preferred embodiment of the first or second aspect of the invention, the indentation lines (4) are arranged such that the relief fields (3a) reflect light differently, such that the relief fields (3a) appear with different brightness and/or color.

In another preferred embodiment of the first or second aspect of the invention, the relief fields (3a) are arranged in a way that they reflect light differently, such that different images are formed depending on the angle of view.

In a particularly preferred embodiment of the first or second aspect of the invention, the cross-sectional profile of the indentation lines (4) is a concave curve (4a).

In another preferred embodiment of the first or second aspect of the invention, the cross-sectional profile of the indentation lines (4) is a concave (4a) or convex curve (4b), wherein the radius (7) of the concave (4a) or convex curve (4b) is from 0.05 mm to 1 mm, preferably from 0.05 mm to 0.5 mm, preferably from 0.1 to 0.3 mm, and more preferably from 0.1 to 0.2 mm.

In another preferred embodiment of the first or second aspect of the invention, the concave (4a) or convex curve (4b) is an arc of circle.

In another preferred embodiment of the first or second aspect of the invention, the at least two parallel straight indentation lines (4) of a relief field (3a) are arranged adjacent next to each other, i.e. without any flat, convex or concave portion between them.

In another preferred embodiment of the first or second aspect of the invention, the at least two parallel straight indentation lines (4) of a relief field (3a) are separated from each other by a convex (8a), concave (8b) or essentially flat portion (8c).

In another preferred embodiment of the first or second aspect of the invention, the ratio of the width (9) of the essentially flat portion (8c) to the width of the indentation lines (6) is less than about 0.55, preferably less than about 0.4, more preferably less than about 0.3, even more preferably less than about 0.2, and most preferably less than about 0.1.

In another preferred embodiment of the first or second aspect of the invention, the concave (4a) or convex curve (4b) of the indentation lines (4) is characterized by a tangential angle (10) of from 40° to 90°, preferably from 40° to 80°, more preferably from 45° to 75° and in some preferred embodiments from 50° to 70°.

In a third aspect, the present invention relates to a mold suitable for manufacturing a molded food product, preferably a confectionery product such as e.g. a chocolate product, presenting on its surface (1b) an optical element (2b) comprising at least three non-overlapping gravure fields (3b), each gravure field (3b) having at least two parallel straight engraving lines (20) providing an orientation of the gravure field (3b), wherein the different gravure fields (3b) are not in parallel orientation to each other.

A preferred embodiment of the present invention relates to the mold according to the third aspect, wherein (i) the depth (5) of the engraving lines (20) is from 0.03 mm to 1 mm; and/or the width (6) of the engraving lines (20) is from 0.1 mm to 2.0 mm.

Another preferred embodiment of the present invention relates to the mold according to the third aspect, wherein (i) the depth (5) of the engraving lines (20) is from 0.03 mm to 1 mm; and/or the width (6) of the engraving lines (20) is from 0.1 mm to 2.0 mm; and/or (ii) the cross-sectional profile of the engraving lines (20) is a convex (20a) or concave curve (20b); and/or (iii) the convex (20a) or concave curve (20b) of the engraving lines (20) is characterized by a tangential angle (10) of from 40° to 120°.

In a preferred embodiment of the third aspect of the invention, the at least two parallel straight engraving lines (20) of the at least two non-overlapping gravure fields (3b) are oriented at an angle of at least 10° to each other.

In a fourth aspect, the invention relates to a mold suitable for manufacturing a molded food product, preferably a confectionery product such as e.g. a chocolate product, presenting on its surface (1b) an optical element (2b) comprising at least two non-overlapping gravure fields (3b), each gravure field (3b) having at least two parallel straight engraving lines (20) providing an orientation of the gravure field (3b), wherein the at least two non-overlapping gravure fields (3b) are oriented at an angle of at least 10° to each other, and wherein (i) the depth (5) of the engraving lines (20) is from 0.03 mm to 1 mm; and/or the width (6) of the engraving lines (20) is from 0.1 mm to 2.0 mm; (ii) the cross-sectional profile of the engraving lines (20) is a convex (20a) or concave curve (20b); and (iii) the convex (20a) or concave curve (20b) of the engraving lines (20) is characterized by a tangential angle (10) of from 40° to 120°.

In a preferred aspect of the third aspect of the invention, the invention relates to a mold suitable for manufacturing a molded food product, preferably a confectionery product such as e.g. a chocolate product, presenting on its surface (1b) an optical element (2b) comprising at least two non-overlapping gravure fields (3b), each gravure field (3b) having at least two parallel straight engraving lines (20) providing an orientation of the gravure field (3b), wherein the at least two non-overlapping gravure fields (3b) are oriented at an angle of at least 10° to each other, and wherein (i) the depth (5) of the engraving lines (20) is from 0.03 mm to 1 mm and the width (6) of the engraving lines (20) is from 0.1 mm to 2.0 mm; (ii) the cross-sectional profile of the engraving lines (20) is a convex (20a) or concave curve (20b); and (iii) the convex (20a) or concave curve (20b) of the engraving lines (20) is characterized by a tangential angle (10) of from 40° to 120°.

In a preferred embodiment of the third or fourth aspect of the invention, the optical element (2b) comprises from 4 to 200, from 10 to 150, from 20 to 100, or from 30 to 50 gravure fields (3b) and wherein, preferably, these different gravure fields (3b) are oriented in at least 5, 6, 7, 8, 9, 10, 15, 20, or 50 different directions.

In another preferred embodiment of the third or fourth aspect of the invention, the at least two non-overlapping gravure fields (3b) are oriented at an angle of from 15° to 350°, from 20° to 300°, from 30° to 135°, from 45° to 90°, from 50° to 80°, or from 50° to 60° to each other.

In a further preferred embodiment of the third or fourth aspect of the invention, the depth (5) of the engraving lines (20) is from 0.04 mm to 0.5 mm, more preferably from 0.04 to 0.1 mm, even more preferably from 0.05 to 0.1 mm, most preferably from 0.06 mm to 0.08 mm or from 0.06 to 0.09 mm. In a preferred embodiment the depth of the engraving lines is around 0.07 mm.

In another preferred embodiment of the third or fourth aspect of the invention, the width (6) of the engraving lines (20) is from 0.1 mm to 1.0 mm, preferably from 0.15 mm to 0.50 mm, more preferably from 0.20 mm to 0.40 mm. In some embodiments the width of the engraving lines is from about 0.20 mm to 0.30 mm.

In a particularly preferred embodiment of the third or fourth aspect of the invention, the cross-sectional profile of the engraving lines (20) is a convex curve (20a).

In another preferred embodiment of the third or fourth aspect of the invention, the cross-sectional profile of the engraving lines (20) is a convex (20a) or concave curve (20b), wherein the radius (7) of the convex (20a) or concave curve (20b) is from 0.05 mm to 1 mm, preferably from 0.05 mm to 0.5 mm, preferably from 0.1 to 0.3 mm, and more preferably from 0.1 to 0.2 mm.

In another preferred embodiment of the third or fourth aspect of the invention, the concave (20b) or convex curve (20a) is an arc of circle.

In another preferred embodiment of the third or fourth aspect of the invention, the at least two parallel straight engraving lines (20) of a gravure field (3b) are arranged adjacent next to each other, i.e. without any flat, convex or concave portion between them.

In another preferred embodiment of the third or fourth aspect of the invention, the at least two parallel straight engraving lines (20) of a gravure field (3b) are separated from each other by a concave (21a), convex (21b) or essentially flat portion (21c).

In another preferred embodiment of the third or fourth aspect of the invention, the ratio of the width (9) of the essentially flat portion (21c) to the width of the engraving lines (6) is less than about 0.55, preferably less than about 0.4, more preferably less than about 0.3, even more preferably less than about 0.2, and most preferably less than about 0.1.

In another preferred embodiment of the third or fourth aspect of the invention, the convex (20a) or concave curve (20b) of the engraving lines is characterized by a tangential angle (10) of from 40° to 90°, preferably from 40° to 80°, more preferably from 45° to 75° and in some preferred embodiments from 50° to 70°.

In a fifth aspect, the invention relates to a process for manufacturing a molded food product, preferably a confectionery product such as e.g. a chocolate product, comprising applying on the surface (1a) of said product an optical element (2a) as defined above for the first and second aspect of the invention.

In a preferred embodiment of the present invention, the process according to the fifth aspect comprises the steps of a. Providing a food product at a temperature at which it is in liquid state; b. Pouring the food material into a mold of the invention; c. Solidifying the food material by cooling; and d. Removing the solidified food product from the mold.

In a sixth aspect, the present invention relates to a process for preparing a changing image on the surface of a food product, said process comprising the steps of a) providing an image; b) converting the image into an optical element (2b) representing the image by: (i) dividing the image into different colour fields or shades, (ii) assigning to each colour or shade one or more gravure fields (3b) of identical orientation, wherein the orientation of a gravure field (3b) is determined by the orientation of the at least two parallel straight engraving lines (20) comprised in said gravure field (3b), such that each colour or shade determines a certain orientation of the gravure field (3b), and the parallel straight engraving lines (20) assigned to gravure fields (3b) of different colours or shades do not have the same orientation, c) preparing a mold according to the invention; and d) using the mold for preparing a molded food product.

In another preferred embodiment of the sixth aspect of the present invention, step d) of using the mold for preparing a molded food product is performed according to the fifth aspect of the invention or its preferred embodiment.

Other aspects and embodiments of the present invention are described below, and/or are depicted in the drawings.

### BRIEF DESCRIPTION OF THE DRAWINGS

FIG. 1A is a schematic top view of an exemplary optical element of a mold according to the invention providing a radial spiral image. FIG. 1A displays various gravure fields with parallel straight engraving lines.

FIG. 1B shows a single gravure field of the optical element of FIG. 1A.

FIG. 2A is a schematic top view of an exemplary optical element of a molded food product according to the invention providing a changing image product logo, wherein the image changes between a product logo pattern and several heart shaped patterns depending on the viewing angle. FIG. 2A displays a multitude of relief fields.

FIG. 2B shows the indentation lines of the relief fields of the optical element of FIG. 2A.

FIG. 3 is a schematic cross-sectional view of one of the relief fields of the molded food product of the invention (see FIG. 3B) and a schematic cross-sectional view of the corresponding gravure field of the mold (see FIG. 3A), wherein the at least two parallel straight indentation lines of a relief field are arranged adjacent next to each other, i.e. without any flat, convex or concave portion between them, and wherein the cross-sectional profile of each indentation line of the relief field of the molded product is a concave curve (see FIG. 3B).

FIG. 4 is a schematic cross-sectional view of one of the relief fields of the molded food product of the invention (see FIG. 4B) and a schematic cross-sectional view of the corresponding gravure field of the mold (see FIG. 4A), wherein the at least two parallel straight indentation lines of a relief field are arranged adjacent next to each other, i.e. without any flat, convex or concave portion between them, and wherein the cross-sectional profile of each indentation lines of the relief field of the molded product is a convex curve (see FIG. 4B).

FIG. 5 is a schematic cross-sectional view of one of the relief fields of the molded food product of the invention (see FIG. 5B) and a schematic cross-sectional view of the corresponding gravure field of the mold (see FIG. 5A), wherein the cross-sectional profile of each indentation line is a concave curve, and the at least two parallel straight indentation lines of a relief field are separated from each other by an essentially flat portion.

FIG. 6 is a schematic cross-sectional view of one of the relief fields of the molded food product of the invention (see FIG. 6B) and a schematic cross-sectional view of the corresponding gravure field of the mold (see FIG. 6A), wherein the cross-sectional profile of each indentation line is a concave curve, and the at least two parallel straight indentation lines of a relief field are separated from each other by a convex portion.

FIG. 7 is a schematic cross-sectional view of one of the relief fields of the molded food product of the invention (see FIG. 7B) and a schematic cross-sectional view of the corresponding gravure field of the mold (see FIG. 7A), wherein the cross-sectional profile of each indentation line is a convex curve, and the at least two parallel straight indentation lines of a relief field are separated from each other by an essentially flat portion.

FIG. 8 is a schematic cross-sectional view of one of the relief fields of the molded food product of the invention (see FIG. 8B) and a schematic cross-sectional view of the corresponding gravure field of the mold (see FIG. 8A), wherein the cross-sectional profile of each indentation line is a convex curve, and the at least two parallel straight indentation lines of a relief field are separated from each other by a concave portion.

FIG. 9 to 15 are schematic cross-sectional views of the molds used for preparing the chocolate products of the Examples (further explanations are found in the example section).

### DETAILED DESCRIPTION OF THE INVENTION

The present invention provides a molded food product, preferably a confectionery product such as e.g. a chocolate product, presenting on its surface (1a) an optical element (2a) comprising at least three non-overlapping relief fields (3a), each relief field (3a) having at least two parallel straight indentation lines (4) providing an orientation of the relief field (3a), wherein the respective different relief fields (3a) are not in parallel orientation to each other.

In the context of the present invention, a molded food product is to be understood as a product having any desired three-dimensional shape and that is produced by any conventional molding process. As commonly understood, molding is the casting of liquid chocolate into molds (e.g. plastic or metal) followed by cooling and demolding.

The term “food product”, as used herein, refers to food, confections, candies, and medicines that may be safely consumed by humans or animals, and that are opaque, transparent or semi-transparent. In a preferred embodiment of the present invention, the food product is a fat-based confectionery product such as a chocolate or a chocolate-like composition, e.g. compound coating, praline, truffle, etc. The chocolates and chocolate-like compositions of the present invention may be in any form, e.g. a solid block, a hollow shell, or a shell filled with a confectionery material such as fondant, fudge or soft caramel.

It has been surprisingly found that a particular ratio of depth (5) and width (6) of the indentation lines (4) is required to obtain a desired optical effect, e.g. a light refracting effect. The particular ratios can be derived from the particular aspects and embodiments of the invention. Furthermore, it has been surprisingly found that a specific selection of angles between the indentation lines (4) of different relief fields (3a) further improves the invention. Finally, it was unexpectedly found that the arrangement of at least three non-overlapping relief fields (3a) on the product surface (1a) itself allows to produce superior optical effects.

In one preferred embodiment the surface of the food product on which the optical element of the invention is present is a substantially flat surface. However in other embodiments the optical image may be present on a curved surface.

Optical Element

In the context of the present invention, the term “optical element” or “optical elements” refers to any type of surface structure that provides a visually appealing image and/or effect, e.g. concave/convex light reflection effects, giving changing images and/or holographic-like effects.

As used herein, the term “image” or “images” refers to any kind of visible pattern, such as a picture, drawing, figure, logo, character, design, reflection, etc.

A changing image effect may be generally achieved by creating a three-dimensional surface design having specific diffraction gratings that allow the light to refract from the surface while being scattered by the gratings. The embossed design can be seen at certain angles. When the surface is viewed from different perspectives, different parts will appear in different colours or shades, creating a rainbow or other optical effect with the design still visible.

Relief Fields

The optical element (2a) of the present invention comprises at least two non-overlapping relief fields (3a), each relief field (3a) having at least two parallel straight indentation lines (4). As used herein, a relief field (3a) is a defined area on the surface (1a) of the food product, which is characterized by a defined shape and area size. Depending on the image or effect to be achieved, the optical element (2a) may comprise two or three relief fields (3a), e.g. from at least two up to any suitable number, or e.g. from at least three up to any suitable number, and preferably a multiple number such as from 5 to 200, from 10 to 150, from 20 to 100, from 30 to 50, or any integer number within the above described ranges. In a further embodiment the optical element (2a) may comprise 2, 3, 5, 10, 20, 30, 40, 50, 75, 100 or 200 relief fields (3a).

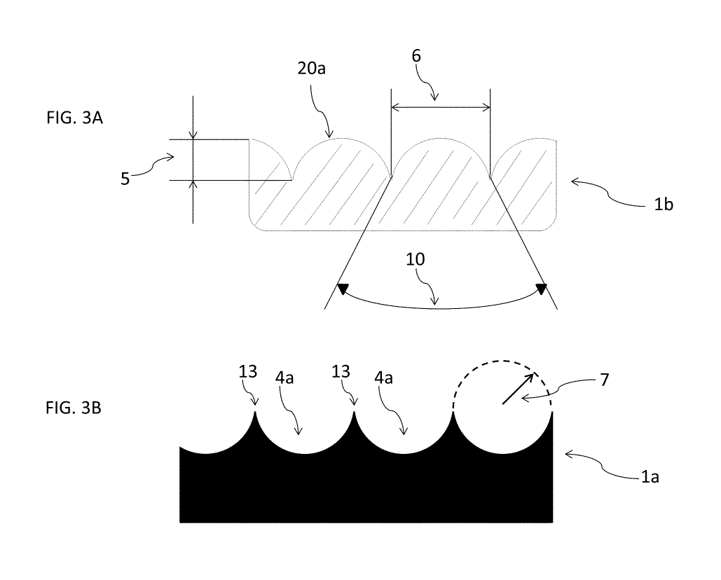

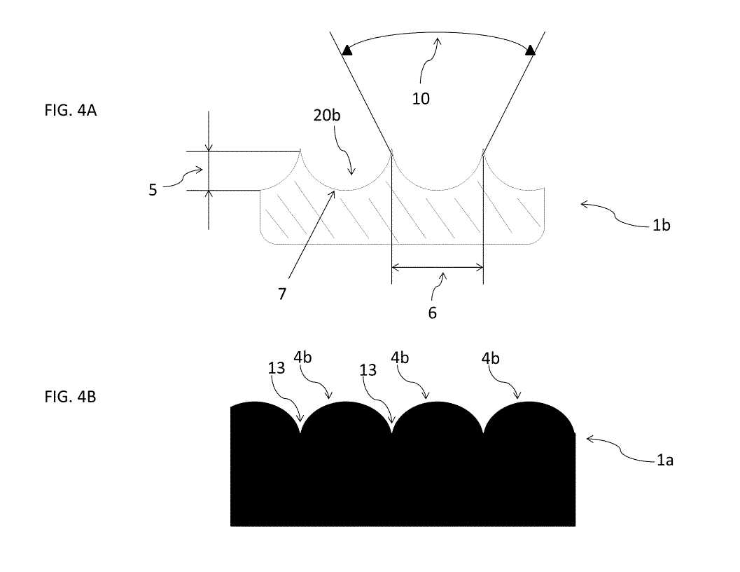

The relief fields (3a) of the present invention can be of any shape and size, depending on the image and/or effect that is desired to be achieved. By way of non-limiting example, FIG. 2 shows a changing image product logo, wherein the image changes between a product logo pattern and several heart shaped patterns depending on the viewing angle (FIG. 2A). As can be seen from FIG. 2B, this effect is achieved by a particular linear arrangement of relief fields (3a) having parallel straight indentation lines (4) of a certain angle. The particular patterns are generated by a corresponding arrangement of different relief fields (3a), while the different images are generated by varying the angle of the indentation lines (4) of said relief fields (3a).

As can be derived from the above example, the multiple relief fields (3a) of the optical element (2a) of the product are oriented at different angles, i.e. orientations, to produce the desired effect and images. As used herein, “the angle” or “orientation” of two relief fields “A” and “B” is determined by the angle of the parallel straight indentation lines (4) of relief field “A” to the angle of the parallel straight indentation lines (4) of relief field “B” in relation to each other.

Typically, the indentation lines (4) of the at least two relief fields (3a) are oriented at an angle of at least 10°, e.g. from 15° to 350°, from 20° to 300°, from 30° to 135°, from 45° to 90°, from 50° to 80°, or from 50° to 60° to each other.

The number of the indentation lines (4) in each relief field (3a) may be from at least two up to any suitable number, e.g. from 5 to 200, 10 to 150, 20 to 100, or 30 to 50.

It is preferred that the indentation lines (4) are arranged such that the multiple relief fields (3a) reflect light differently, such that the different relief fields (3a) appear with different brightness and/or colour and/or shade and/or such that different images are formed depending on the angle of view.

Indentation Lines

As used herein, indentation lines (4) are parallel straight deepenings or elevations (protrusions) in the product surface (1a), which may be a plain or curved surface, wherein said deepenings or elevations may have any length depending of the desired image or effect.

In a preferred embodiment of the present invention, the cross-sectional profile of each indentation line (4) is a concave (4a) or convex curve (4b).

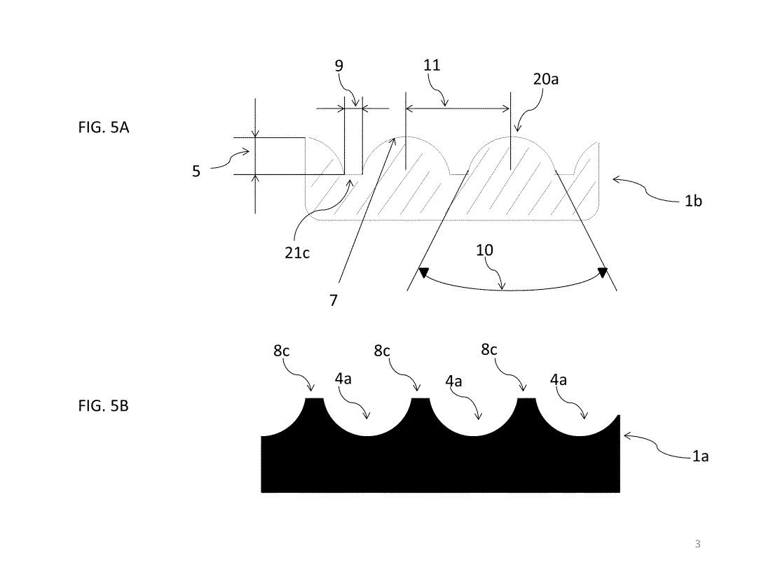

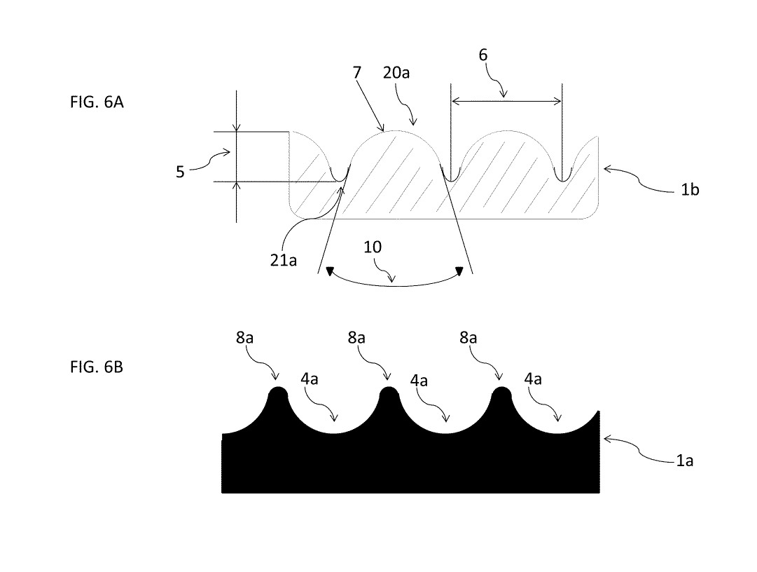

As used herein, the radius (7) is defined as the radius of the imaginary circle of the completed curve of the indentation line (4), see FIG. 3B. In FIG. 4-8B, the radius (7) is correspondingly shown for the convex or concave curve of the engraving line (20) of the corresponding mold. Preferably, the radius (7) of the concave (4a) or convex curve (4b) is from 0.05 mm to 1 mm, preferably from 0.05 mm to 0.5 mm, preferably from 0.1 to 0.3 mm, and more preferably from 0.1 to 0.2 mm.

Preferably, the concave (4a) or convex curve (4b) is an arc of circle.

Also preferably, the depth (5) of the concave (4a) or convex curve (4b) of the indentation line (4) is from 0.03 mm to 1 mm, preferably from 0.04 mm to 0.5 mm, more preferably from 0.04 to 0.1 mm, even more preferably from 0.05 to 0.1 mm, such as from 0.06 mm to 0.08 mm. In this context, the depth (5) of the curve of the indentation line (4) as well as of the engraving line (20) is defined as the maximal distance between the highest and the lowest point of the curve when measured perpendicular to the product surface (1a) and the mold surface (1b), respectively. In the attached Figures, the depth (5) is exemplified on the mold (see FIG. 3A to 8A). However, the skilled person will appreciate that the depth of the engraving line (20) and the height of the corresponding indentation line (4) is identical, and vice versa.

Furthermore, it is preferred that the width (6) of the concave (4a) or convex curve (4b) is from 0.1 mm to 2.0 mm, is from 0.1 mm to 1.0 mm, preferably from 0.15 mm to 0.50 mm, more preferably from 0.20 mm to 0.40 mm, more preferably from 0.20 to 0.30 mm and in some preferred embodiments from 0.22 mm to 0.36 mm.

As used herein, the width (6) of the concave (4a) or convex curve (4b) of the indentation line (4) as well as of the engraving line (20) is defined as the maximum width of the curve when measured perpendicular to the longitudinal direction. In the attached Figures, the width (6) is exemplified on the mold (see FIG. 3A to 8A). However, the skilled person will appreciate that the width (6) of the engraving line (20) and that of the corresponding indentation line (4) is identical, and vice versa.

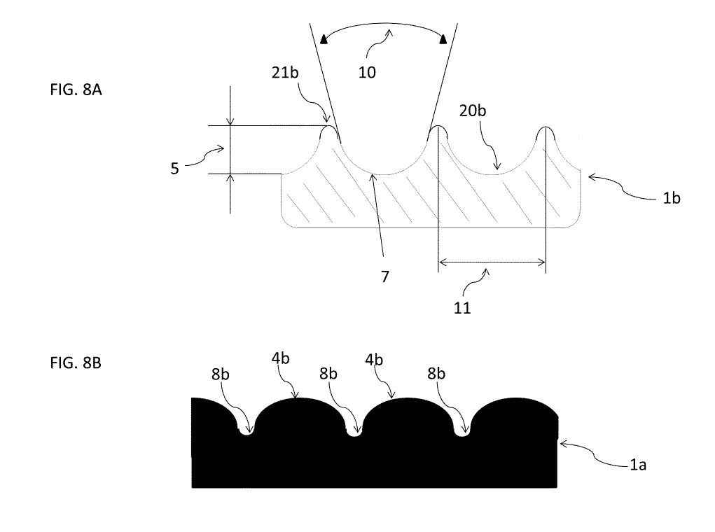

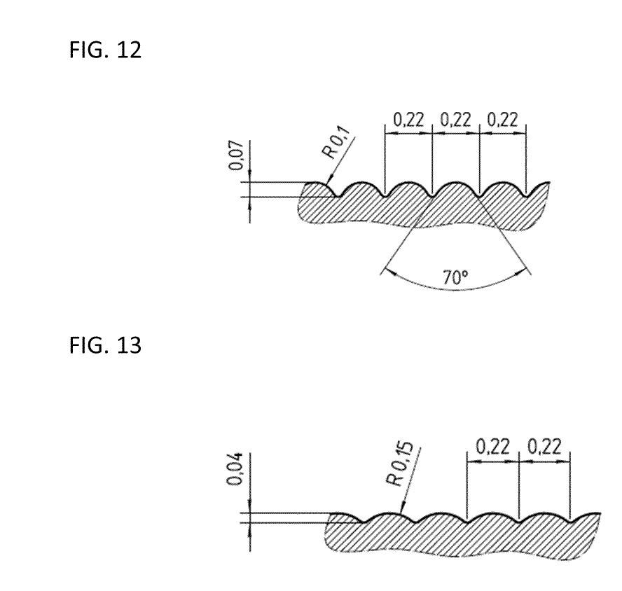

If the indentation lines (4) of a relief field (3a) are arranged adjacent next to each other, i.e. without any separating portion (8) between them, this maximum width is measured between the highest or lowest points (13) of adjacent indentation lines (4) (see FIGS. 3A and 4A). If the indentation lines (4) of a relief field (3a) are separated by a convex (8a) or concave portion (8b), this maximum width (6) is measured between the highest points of adjacent convex separating portions (8a), or between the deepest points of adjacent concave separating portions (8b), respectively (see FIGS. 6A and 8A).

Parallel arranging the straight indentation lines (4) leads to a formation of ridges between these lines, and thus to a specific grating of the relief fields (3a). The separating portion (8) between the indentation lines (4) constituting the top of these ridges may be shaped as a convex (8a), concave (8b) or essentially flat portion (8c) or plane, which depending on the distance of the parallel indentation lines (4) may vary in width (9).

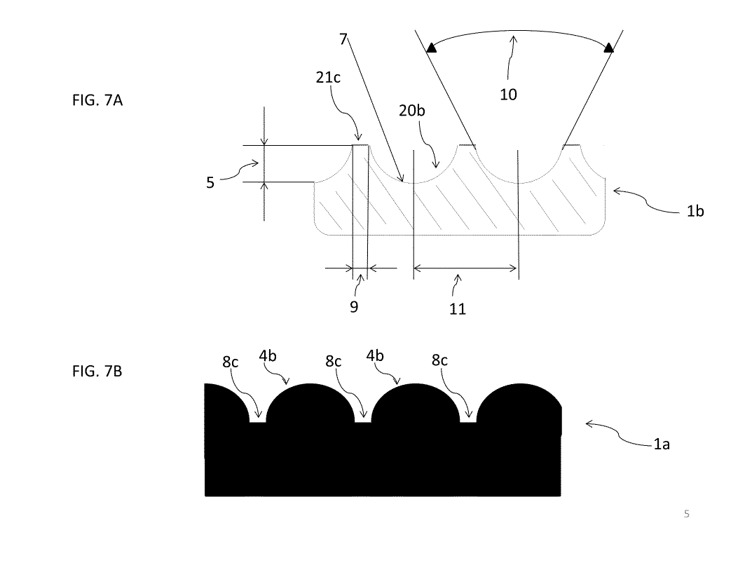

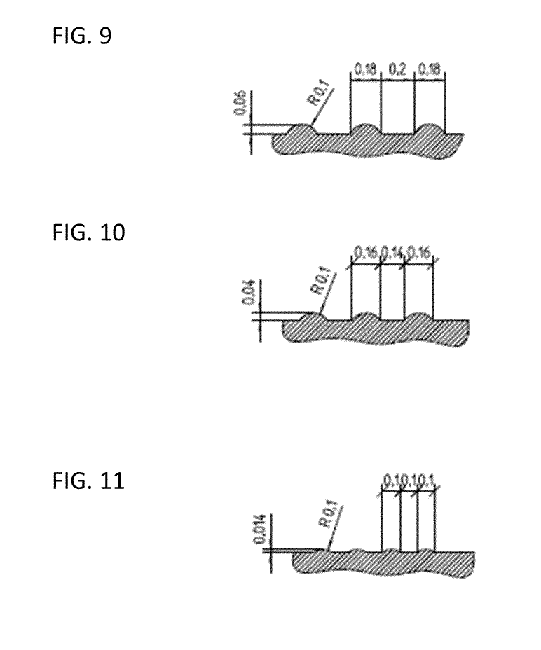

In the attached Figures, the width (9) is exemplified on the mold (see FIGS. 5A and 7A). However, the skilled person will appreciate that the width (9) of the separating portion (21c) and that of the corresponding separating portion (8c) is identical, and vice versa.

It is preferred that the width (9) of the separating portion (21c) and that of the corresponding separating portion (8c) is from 0.01 mm to 1.0 mm, preferably from 0.01 mm to 0.5 mm, more preferably from 0.01 mm to 0.1 mm.

If the cross-sectional profile of the indentation lines (4) is a concave curve (4a), the separating portion (8) between these lines may be convex (8a) or essentially flat (8c), see FIGS. 5B and 6B. If the cross-sectional profile of the indentation lines (4) is a convex curve (4b), the separating portion (8) between these lines may be concave (8b) or essentially flat (8c), see FIGS. 7B and 8B.

In one preferred embodiment, the separating portion (8) is essentially flat.

In a preferred embodiment of the molded food product, the ratio of the width (9) of the essentially flat portion (8c) between the indentation lines (4) to the width of the indentation lines (6) is less than about 0.55, preferably less than about 0.4, more preferably less than about 0.3, even more preferably less than about 0.2, and most preferably less than about 0.1.

As used herein, the width of the indentation lines (4) is identical to the width (6) of the concave (4a) or convex curve (4b) of the indentation line (4). In those embodiments, wherein the indentation lines are separated by a convex (8a), concave (8b) or essentially flat portion (8c), the width of the indentation lines is calculated by subtracting the width (9) of the separating portion (8) between the indentation lines (4) from the maximum distance (11) between the highest or lowest points of the concave (4a) or convex curves (4b) of adjacent indentation lines (as exemplified in FIGS. 5A, and 7A for the corresponding mold).

In one particularly preferred embodiment, the at least two parallel straight indentation lines (4) of a relief field (3a) are arranged adjacent next to each other, i.e. without any convex (8a), concave (8b) or essentially flat separating portion (8) between them. In this preferred case, the ratio of the width (9) of the convex (8a), concave (8b) or essentially flat portion (8c) between the indentation lines (4) to the width of the indentation lines (6) is preferably less than 0.01.

In yet another preferred embodiment of the molded food product, the concave (4a) or convex curve (4b) of the indentation lines (4) is characterized by a tangential angle (10) of from 40° to 120°, preferably from 40° to 90°, preferably from 40° to 80°, more preferably from 45° to 75° and in some preferred embodiments from 50° to 80° or 50° to 70°. Preferably, said angle can be about 45°, 50°, 60°, 70°, 75°, or 80° or less than about 45°, 50°, 60°, 70°, 75°, or 80°.

The tangential angle (10) is determined as the angle between the tangents of the concave (4a) or convex curve (4b) of the indentation line (4). These tangents are constructed at the inflection point between the convex curve of the engraving line (4b) and the concave curve of the separating portion (8a), or between the concave curve of the engraving line (4a) and the convex curve of the separating portion (8b), respectively. Thus, each curve has two tangents (see FIGS. 6A and 8A). In these Figures, the angle (10) is exemplified on the mold. However, the skilled person will appreciate that the angle (10) of the convex (4b) or concave engraving line (4a) of the product and the angle (12) of the corresponding concave (20b) or convex separating portion (20a) of the mold is identical, and vice versa.

In case that the separation portion is flat (8c) the angle between the two tangents is determined as follows: The tangential angle (10) is determined as the angle between the tangents of the concave (4a) or convex curve (4b) of the indentation line (4). These tangents are constructed at the point where the curve intersects with the flat portion (8c) of the ridge. Thus, each curve has two tangents (see FIGS. 5A and 7A). In these Figures, the angle (10) is exemplified on the mold. However, the skilled person will appreciate that the angle (10) between the tangents of the concave (4a) or convex curve (4b) of the indentation line (4) of the product and the angle (10) of the corresponding concave (20b) or convex curve (20a) of the engraving line (20) of the mold is identical, and vice versa.

Mold

The present invention further provides a mold suitable for manufacturing a molded food product, preferably a confectionery product such as e.g. a chocolate product, presenting on its surface (1b) an optical element (2b) comprising at least three non-overlapping gravure fields (3b), each gravure field (3b) having at least two parallel straight engraving lines (20) providing an orientation of the gravure field (3b), wherein the different gravure fields (3b) are not in parallel orientation to each other.

For the present invention, any mold conventionally used in food industry can be used. In accordance with an exemplary embodiment of the present invention, one or more relief-type molds are utilized to produce a food product with incorporated optical elements. Each relief-type mold includes one or more diffractive, holographic or lenticular relief patterns or gratings on the surface of the mold.

The shape and dimensions of the molds used in connection with the present invention will depend on many factors, including, but not limited to, spatial constraints, the type of food products being produced, etc. The present invention is applicable, however, to embodiments in which anywhere from one mold to a multiplicity of molds are employed simultaneously or over a staggered time frame to produce one or more edible articles.

The molds may be either metal-, rubber-, plastic-, or wax-based, but, preferably, are made of a material that facilitates removal of the dried substrate from the mold without the former adhering to (i.e., sticking to) the latter. Exemplary plastic-based molds include those made of silicone, polytetrafluoroethylene or polyethylene terephthalate, and an exemplary metal-based mold is made of a nickel-based material.

Typically, the mold is shaped in way that the optical element (2b) presented on its surface (1b) is the exact negative of the optical element (2a) comprised in the molded food product of the invention.

Gravure Fields

The optical element (2b) of the mold comprises at least two non-overlapping gravure fields (3b), each gravure field (3b) having at least two parallel straight engraving lines (20). As used herein, a gravure field (3b) is a defined area on the surface (1b) of the mold, which is characterized by a defined shape and area size. Depending on the image or effect to be achieved, the optical element (2b) may comprise two or three gravure fields (3b), e.g. from at least two up to any suitable number, or e.g. from at least three up to any suitable number, and preferably a multiple number such as from 5 to 200, from 10 to 150, from 20 to 100, from 30 to 50, or any integer number within the above described ranges. In a further embodiment the optical element (2b) may comprise 2, 3, 5, 10, 20, 30, 40, 50, 75, 100 or 200 gravure fields (3b).

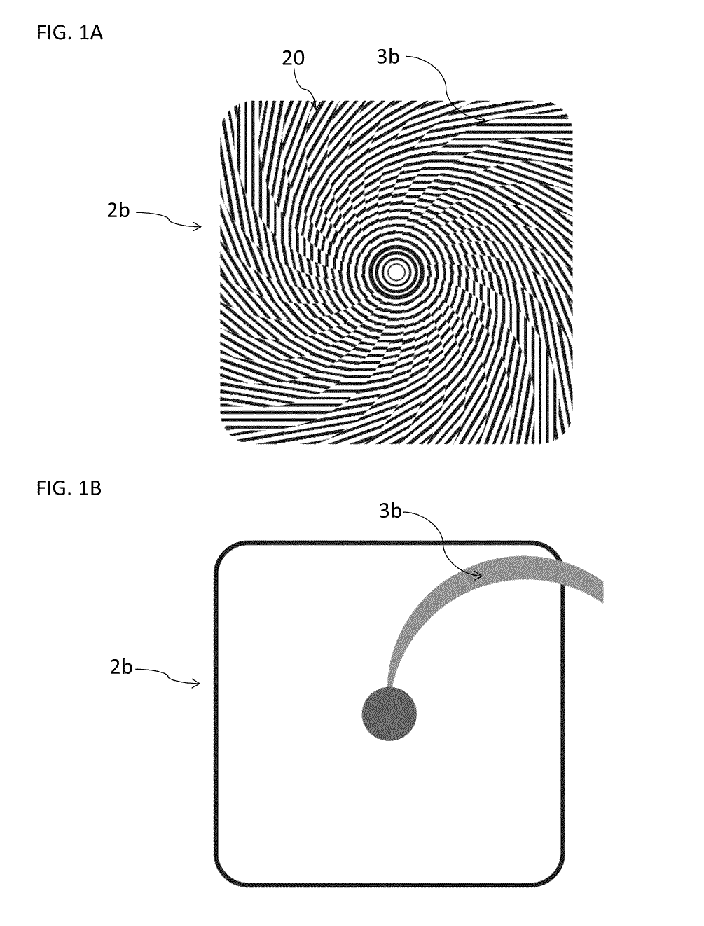

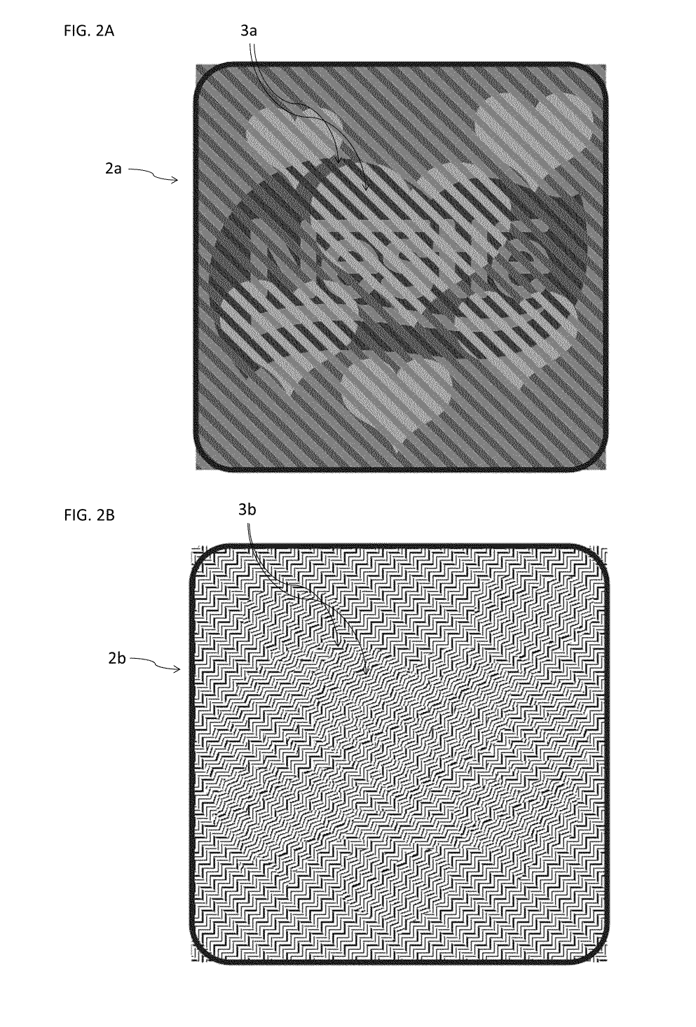

The gravure fields (3b) of the present invention can be of any shape and size, depending on the image and/or effect that is desired to be achieved. By way of non-limiting example, FIG. 1 displays an embodiment of the present invention in the form of a spiral image hologram. In order to arrive at a spiral appearance, the particular gravure fields (3b) are arcuate shaped (FIG. 1A) and arranged concentrically around a single midpoint. As can be seen from FIG. 1B, each of these gravure fields (3b) is characterized by a specific grating composed of parallel straight engraving lines (20), wherein the engraving lines (20) of neighbored gravure fields (3b) are oriented around the midpoint and their orientation differs by an angle of at least 10° in relation to each other.

As can be derived from the above example, the multiple gravure fields (3b) of the optical element (2b) of the mold are oriented at different angles, i.e. orientations, to produce the effect and image. As used herein, “the angle” or “orientation” of two gravure fields “A” and “B” is determined by the angle of the parallel straight engraving lines (20) of gravure field “A” to the angle of the parallel straight engraving lines (20) of gravure field “B” in relation to each other.

Typically, the engraving lines (20) of the at least two gravure fields (3b) form an angle of at least 10°, e.g. from 15° to 350°, from 20° to 300°, from 30° to 135°, from 45° to 90°, from 50° to 80°, or from 50° to 60°.

The number of the engraving lines (20) in each gravure field (3b) may be from at least two up to any suitable number, e.g. from 5 to 200, 10 to 150, 20 to 100, or 30 to 50.

It is preferred that the engraving lines (20) are arranged such that the multiple gravure fields (3b) reflect light differently, such that the different gravure fields (3b) appear with different brightness and/or colour and/or shade and/or such that different images are formed depending on the angle of view.

Engraving Lines

As used herein, engraving lines (20) are parallel straight deepenings or elevations (protrusions) in the mold surface (1b), which may be a plain or curved surface, wherein said deepenings or elevations may have any length depending of the desired image or effect.

In a preferred embodiment of the present invention, the cross-sectional profile of the engraving lines (20) is a convex (20a) or concave curve (20b).

Preferably, the radius (7) of the convex (20a) or concave curve (20b) is from 0.05 mm to 1 mm, preferably from 0.05 mm to 0.5 mm, preferably from 0.1 to 0.3 mm, and more preferably from 0.1 to 0.2 mm.

Also preferably, the depth (5) of the convex (20a) or concave curve (20b) of the engraving line (20) is from 0.03 mm to 1 mm, preferably from 0.04 mm to 0.5 mm, more preferably from 0.04 to 0.1 mm, even more preferably from 0.05 to 0.1 mm, most preferably from 0.06 mm to 0.08 mm or from 0.06 to 0.09 mm.

Furthermore, it is preferred that the width (6) of the convex (20a) or concave curve (20b) is from 0.1 mm to 2.0 mm, preferably from 0.1 mm to 1.0 mm, preferably from 0.15 mm to 0.50 mm, more preferably from 0.20 mm to 0.40 mm, in some preferred embodiments from 0.22 mm 0.36 mm.

Parallel arranging the straight engraving lines (20) leads to a formation of ridges between these lines, and thus to a specific grating of the gravure fields (3b). The separating portion (21) between the engraving lines (20) constituting the top of these ridges may be shaped as a concave (21a), convex (21b) or essentially flat portion (21c) or plane, which depending on the distance of the parallel engraving lines (20) may vary in width (9).

If the cross-sectional profile of the engraving lines (20) is a concave curve (20b), the separating portion (21) between these lines may be convex (21b) or essentially flat (21c), see FIGS. 7A and 8A.

If the cross-sectional profile of the engraving lines (20) is a convex curve (20a), the separating portion (21) between these lines may be concave (21a) or essentially flat (21c), see FIGS. 5A and 6A.

In a preferred embodiment of the mold, the ratio of the width (9) of the essentially flat portion (21c) between the engraving lines (20) to the width of the engraving lines (6) is less than about 0.55, preferably less than about 0.4, more preferably less than about 0.3, even more preferably less than about 0.2, and most preferably less than about 0.1.

In one particularly preferred embodiment, the at least two parallel straight engraving lines (20) of a gravure field (3b) are arranged adjacent next to each other, i.e. without any convex (21b), concave (21a) or essentially flat separating portion (21c) between them.

In yet another preferred embodiment of the mold, the convex (20a) or concave curve (20b) of the engraving lines (20) is characterized by a tangential angle (10) of from 40° to 120°, from 40° to 90°, preferably from 40° to 80°, more preferably from 45° to 75° and in some preferred embodiments from 50° to 70°.

In one preferred embodiment, the separating portion (21c) between the at least two parallel straight engraving lines (20) of a gravure field (3b) is flat.

In case that the separation portion is flat (21c) the angle between the two tangents is determined as follows: The tangential angle (10) is determined as the angle between the tangents of the concave convex (20a) or concave curve (20b) of the engraving line (20). These tangents are constructed at the point where the curve intersects with the flat portion (21c) of the ridge. Thus, each curve has two tangents (see FIGS. 5A and 7A).

Process for Manufacturing

The invention further relates to a process for manufacturing a molded food product, preferably a confectionery product such as e.g. a chocolate product, comprising applying on the surface (1a) of said product an optical element (2a) as defined above.

The molding of the food product can be carried out by conventional molding processes, such as chocolate molding processes, well-known to the person skilled in the art.

This process may comprise the steps of a. Providing a food product at a temperature at which it is in liquid state; b. Pouring the food material into a mold of the invention; c. Solidifying the food material by cooling; and d. Removing the solidified food product from the mold.

For liquid chocolate and/or some other of fat based masses a Tempering process is generally carried out before depositing into the mould cavity. The tempering process is a conventional process in chocolate making and it ensures that the cocoa butter or other confectionery fat constituents are seeded and that the chocolate or non-chocolate mass will set in a stable condition with a good permanent color and gloss.

Molding of fat-based confectionery is conventionally carried out by depositing tempered liquid chocolate or fat based masses like compound coatings into metal or plastic molds. The temperature at which the food product is deposited into the mould is sufficiently high for the product to remain liquid during the depositing. For instance tempered liquid chocolate is generally deposited into moulds at a temperature in the range of about 28 to 33° C. and compound coating is generally deposited into moulds at a temperature in the range of about 28-45° C. This is followed by an efficient shaking/vibration to eliminate any bubbles/air traps in the liquid mass before the cooling step.

The finished chocolates may be a solid block, a hollow shell, or a shell filled with a confectionery mass such as praline, soft caramel, ganache, fondant or any of the filling masses used in confections.

Furthermore, the present invention relates to a process for preparing a changing image on the surface of a food product, said process comprising the steps of a) providing an image; b) converting the image into an optical element (2b) representing the image by: (i) dividing the image into different colour fields or shades, (ii) assigning to each colour or shade one or more gravure fields (3b) of identical orientation, wherein the orientation of a gravure field (3b) is determined by the orientation of the at least two parallel straight engraving lines (20) comprised in said gravure field (3b), such that each colour or shade determines a certain orientation of the gravure field (3b), and the parallel straight engraving lines (20) assigned to gravure fields (3b) of different colours or shades do not have the same orientation, c) preparing a mold according to the invention; and d) using the mold for preparing a molded food product.

In the inventive process, the optical elements (2a) and (2b), gravure fields (3a) and (3b), indentation lines (4) and engraving lines (20) are defined as set out above. Also, generally, the term food product is to be understood as defined above. Preferably, the molded food product is the product according to the present invention.

The following examples are provided to further illustrate the present invention. They are not intended to be limiting the scope of the present invention.

### EXAMPLES

### Example 1

### Spiral Image Hologram

A chocolate is prepared using a mold. The mold used for preparing the chocolate product is shown in FIG. 1. Therein, the particular gravure fields are arcuate shaped (FIG. 1B) and arranged concentrically around a single midpoint (FIGS. 1A and 1B). As can be seen from this Figure, each of these gravure fields is characterized by a specific grating composed of parallel straight engraving lines, wherein the engraving lines of neighbored gravure fields are rotated around the midpoint by an angle of 10°.

The optical effect of an animated/changing spiral image, with the image changing on angle of view is obtained.

### Reference Example 2

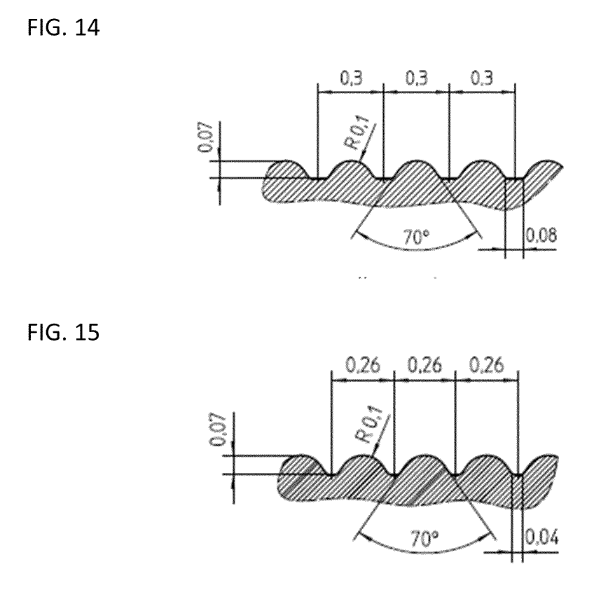

A chocolate was formed using a mold, wherein the at least two parallel straight engraving lines are separated from each other by an essentially flat portion, wherein the ratio of the width of the flat portion to the width of the engraving lines is 0.2/0.18=1.11 (see FIG. 9).

Optical effect is not obtained.

### Reference Example 3

A chocolate was formed using a mold, wherein the at least two parallel straight engraving lines are separated from each other by an essentially flat portion, wherein the ratio of the width of the flat portion to the width of the engraving lines is 0.14/0.16=0.88 (see FIG. 10).

Optical effect is not obtained.

### Reference Example 4

A chocolate was formed using a mold, wherein the at least two parallel straight engraving lines are separated from each other by an essentially flat portion, wherein the ratio of the width of the flat portion to the width of the engraving lines is 0.1/0.1=1 (see FIG. 11).

Optical effect is not obtained.

### Example 5

A chocolate was formed using a mold, wherein the at least two parallel straight engraving lines of a gravure field are arranged adjacent next to each other, i.e. essentially without any flat, convex or concave portion between them and the width of the engraving lines is 0.22 mm (see FIG. 12 and FIG. 13).

The optical effect of an animated/changing image, with the image changing on angle of view is obtained.

### Example 6

A chocolate was formed using a mold, wherein the at least two parallel straight engraving lines are separated from each other by an essentially flat portion, wherein the ratio of the width of the flat portion to the width of the engraving lines is 0.08/0.3=0.27% (see FIG. 14)

The optical effect of an animated/changing image, with the image changing on angle of view is obtained.

### Example 7

A chocolate was formed using a mold, wherein the at least two parallel straight engraving lines are separated from each other by an essentially flat portion, wherein the ratio of the width of the flat portion to the width of the engraving lines is 0.04/0.26=0.15 (see FIG. 15).

The optical effect of an animated/changing image, with the image changing on angle of view is obtained.

### Example 8

A chocolate was formed using a mold, wherein the at least two parallel straight engraving lines are separated from each other by a convex separating portion, wherein the width of the engraving lines is 0.22 and the tangential angle of the convex portion is 50° (see FIG. 16).

The optical effect of an animated/changing image, with the image changing on angle of view is obtained.

1. Molded food product, presenting on its surface an optical element comprising at least three non-overlapping relief fields, each relief field having at least two parallel straight indentation lines providing an orientation of the relief field, wherein the respective different relief fields are not in parallel orientation to each other, and the depth of the indentation lines is from 0.03 mm to 1 mm; and/or the width of the indentation lines is from 0.1 mm to 2.0 mm.

2. Molded food product according to claim 1, comprising a characteristic selected from the group consisting of:
the depth of the indentation lines is from 0.03 mm to 1 mm and the width of the indentation lines is from 0.1 mm to 2.0 mm;
the cross-sectional profile of the indentation lines is a concave or convex curve;
the concave or convex curve of the indentation lines has a tangential angle of from 40° to 120°.

3. Molded food product according to claim 1, wherein the at least two parallel straight indentation lines of the at least two non-overlapping relief fields are oriented at an angle of at least 10° to each other.

4. Molded food product according to claim 1, wherein the indentation lines are arranged such that the two relief fields reflect light differently, such that the two different relief fields appear with different brightness and/or color.

5. Molded food product according to claim 1, wherein the at least two relief fields are arranged in a way that they reflect light differently, such that different images are formed depending on the angle of view.

6. Molded food product:
presenting on its surface an optical element comprising at least two non-overlapping relief fields, each relief field having at least two parallel straight indentation lines providing an orientation of the relief field, wherein the at least two non-overlapping relief fields are oriented at an angle of at least 10° to each other: and
the depth of the indentation lines is from 0.03 mm to 1 mm; and/or the width of the indentation lines is from 0.1 mm to 2.0 mm;
the cross-sectional profile of the indentation lines is a concave or convex curve; and
the concave or convex curve of the indentation lines has a tangential angle of from 40° to 120°.

7. Molded food product according to claim 1, wherein the cross-sectional profile of the indentation lines is a concave or convex curve, wherein the radius of the concave or convex curve is from 0.05 mm to 1 mm, and wherein the concave or convex curve is an arc of a circle.

8. Mold suitable for manufacturing a molded food product, presenting on its surface an optical element comprising at least three non-overlapping gravure fields, each gravure field having at least two parallel straight engraving lines providing an orientation of the gravure field, wherein the different gravure fields are not in parallel orientation to each other, and wherein the depth of the engraving lines is from 0.03 mm to 1 mm; and/or the width of the engraving lines is from 0.1 mm to 2.0 mm.

9. Mold suitable for manufacturing a molded food product comprising:
on its surface an optical element comprising at least two non-overlapping gravure fields, each gravure field having at least two parallel straight engraving lines providing an orientation of the gravure field, wherein the at least two non-overlapping gravure fields are oriented at an angle of at least 10° to each other;
the depth of the engraving lines is from 0.03 mm to 1 mm; and/or the width of the engraving lines is from 0.1 mm to 2.0 mm;
the cross-sectional profile of the engraving lines is a convex or concave curve; and
the convex or concave curve of the engraving lines has a tangential angle of from 40° to 120°.

10. Mold according to claim 8, wherein the cross-sectional profile of the engraving lines is a convex or concave curve, wherein the radius of the convex or concave curve is from 0.05 mm to 1 mm, and the convex or concave curve is an arc of a circle.

11. Process for manufacturing a molded food product, comprising applying on the surface of the product an optical element comprising at least three non-overlapping relief fields, each relief field having at least two parallel straight indentation lines providing an orientation of the relief field, wherein the respective different relief fields are not in parallel orientation to each other, and the depth of the indentation lines is from 0.03 mm to 1 mm; and/or the width of the indentation lines is from 0.1 mm to 2.0 mm.

12. Process for making a food product, comprising the steps:
providing a food product at a temperature at which it is in liquid state;
pouring the food material into a mold presenting on its surface an optical element comprising at least two non-overlapping relief fields, each relief field having at least two parallel straight indentation lines providing an orientation of the relief field, wherein the at least two non-overlapping relief fields are oriented at an angle of at least 10° to each other, the depth of the indentation lines is from 0.03 mm to 1 mm; and/or the width of the indentation lines is from 0.1 mm to 2.0 mm, the cross-sectional profile of the indentation lines is a concave or convex curve; and the concave or convex curve of the indentation lines has a tangential angle of from 40° to 120°;
solidifying the food material by cooling; and
removing the solidified food product from the mold.

13. Process for preparing a changing image on the surface of a food product, the process comprising the steps of
providing an image;
converting the image into an optical element representing the image by:
dividing the image into different colour fields or shades,
assigning to each colour or shade one or more gravure fields of identical orientation,
wherein
the orientation of a gravure field is determined by the orientation of the at least two parallel straight engraving lines comprised in the gravure field, such that each colour or shade determines a certain orientation of the gravure field, and
the parallel straight engraving lines assigned to gravure fields of different colours or shades do not have the same orientation,
preparing a mold; and
using the mold for preparing a molded food product.

14. Process according to claim 13, wherein the molded food product is a product presenting on its surface an optical element comprising at least three non-overlapping relief fields, each relief field having at least two parallel straight indentation lines providing an orientation of the relief field, wherein the respective different relief fields are not in parallel orientation to each other, and the depth of the indentation lines is from 0.03 mm to 1 mm; and/or the width of the indentation lines is from 0.1 mm to 2.0 mm.

15. (canceled)

16. Molded food product according to claim 6, wherein the cross-sectional profile of the indentation lines is a concave or convex curve, wherein the radius of the concave or convex curve is from 0.05 mm to 1 mm, and wherein the concave or convex curve is an arc of a circle.

17. Mold according to claim 9, wherein the cross-sectional profile of the engraving lines is a convex or concave curve, wherein the radius of the convex or concave curve is from 0.05 mm to 1 mm, and the convex or concave curve is an arc of a circle.
